(19) United States
(12) Patent Application Publication
(10) Pub. No.: US 2004/0224290 A1
(43) Pub. Date: Nov. 11, 2004

(54) Apparatus and method for displaying a horoscope

(76) Inventor: Ronelle J. Moehrke, Fort Lauderdale, FL (US)

Correspondence Address: RONALD V. DAVIDGE, SUITE 514, 3300 UNIVERSITY DRIVE, CORAL SPRINGS, FL, 33065, US

(21) Appl. No.: 10/431,910

(22) Filed: May 8, 2003

(51) Int. Cl. G09B 19/00

(52) U.S. Cl. 434/106

(57) ABSTRACT

A device for displaying an individual horoscope within a housing includes a translucent zodiac plate in front of a lamp, and a transparent planetary plate in front of the zodiac plate, to be viewed through an opening in the housing in front of the planetary plate. The zodiac plate includes wedge-shaped sections representing signs of the zodiac in a circular pattern arranged according to the horoscope, and the planetary plate includes symbols representing locations of the sun, moon, and planets relative to the signs of the zodiac according to the horoscope. The opening is preferably also divided into twelve wedge-shaped sections.

### BACKGROUND OF THE INVENTION

1. Field of the Invention

This invention relates to apparatus for displaying an individual horoscope.

2. Summary of the Background Art

A horoscope, or birth chart, of an individual is a diagram showing the positions of the planets and of the sun and moon in relation to twelve sections of the sky through which the sun appears to revolve around the earth, and further in relation to the earth at the position of the individual's birth. The twelve sections of the sky are conventionally given familiar names of associated constellations of the zodiac.

A horoscope is conventionally shown on a flat medium, such as a piece of paper, in the form of several concentric circles, including an outer ring divided into twelve sections representing the zodiac, having names or symbols representing the individual constellations, and an inner circle or ring divided into twelve sections representing the “houses” of the horoscope. The houses start from a horizontal line representing the horizon, with the ascendant space represented by the name of a constellation, at the left end of the line. This ascendant space is the one that is rising in the east, above the horizon, at the time and location of the individual's birth. The zodiac space at the top of the chart, known as the midheaven, is directly above at the time and location of the individual's birth.

A circular shape, or a pattern of concentric circles, appears to be a readily apparent way to express celestial events observed as occurring on an annular basis that has been used since ancient times in many cultures. For example, the Aztecs used a circular stone calendar wheel. A book on astrology by Georg von Purbach, published in 1515, shows an astrologer's wheel having an inner circle representing the earth; a first circular ring extending around the inner circle and showing representations of the sun, moon, and five planets; a second circular ring showing representations of the twelve zodiac signs; and an outer circular ring showing representations of twelve houses.

The patent art also includes a number of descriptions of flat devices in which circular patterns are used to display aspects of a horoscope or to perform certain geometrical calculations related to the generation and interpretation of a horoscope. In each of these devices, the elements relating to an individual horoscope are adjustable or are removably fastened in place, so that the device can be used repeatedly to display horoscopes of different individuals.

For example, U.S. Pat. No. 4,219,944 describes a wall mountable board having a display surface on which an astrology wheel including a representation of the zodiac is delineated. The astrology wheel is partitioned into multiple zodiac sectors, each embodying a house, with each zodiac sector being partitioned into natal, progressed, and transit regions. Tokens representing the signs of zodiac constellations, the sum, moon, and planets, and further representing planetary relationships are provided, with the astrology wheel and the tokens being characterized by mutually coacting surface portions that cause the tokens to releasably adhere to the display surface. For example, the tokens may be magnetically held on the display surface, the tokens may be held by pins extending into a cork display surface, or the tokens and the display surface may have vinyl surfaces known to releasably stick together on contact.

U.S. Pat. No. 3,996,676 describes a device for displaying a horoscope, including a base disk divided into twelve zodiac house sections, having V-shaped slots disposed in circular arrays about the center of the disk. These slots provide sockets for holding disk-shaped tokens with symbols representing the sun, moon, and planets. The device also includes a house number disk rotatably mounted at the center of the base disk.

U.S. Pat. No. 4,195,424 describes a device for displaying a horoscope, including a lower disk of colored plastic, divided into sections representing twelve houses, and a clear vinyl disk, centrally mounted to rotate on the lower disk, divided into twelve equal sections marked with symbols representing signs of the zodiac. The device also includes two sets of high tack vinyl tabs for removable attachment to the clear vinyl disk, with each of the tabs having a symbol representing the sun, the moon, or a planet.

U.S. Pat. No. 4,306,141 describes a device including a base, a first disk, and a number of transparent disks above the base disk, with each of the rotatably mounted on the base at a common point. The base disk has markings dividing it into twelve sectors, with associated symbols representing the signs of the zodiac. Each of the transparent disks includes a tab having a symbol for a celestial object, together with a number of lines emanating from a point at the base of the tab and extending across the disk at selected angles. When the tabs are rotated to place the symbols for various celestial objects in the location on the base disk corresponding to their locations in a horoscope, the relationships among the lines of the transparent disks show the angular relationships among the celestial bodies.

U.S. Pat. Nos. 4,117,608 and 6,015,295 describe devices for displaying the birth chart of an individual, with U.S. Pat. No. 4,117,608 including a string of 360 beads of similar thickness, extending around a circular disk divided into twelve sections representing the signs of the zodiac. The beads are individually colored to represent planets, houses, lunar nodes, etc.

U.S. Pat. No. 6,015,295 describes apparatus for displaying a circular natal chart, together with the present positions of celestial objects. The circular natal chart is inside a zodiac ring divided according to the signs of the zodiac, on which symbols for individual celestial objects are placed to indicate their present position. to be releasably held by magnetic attraction or by hook and loop fasteners. Thus, only these symbols are moved to indicate changes in the present position of the celestial objects.

Each of the devices described by these prior art patents requires the use of a zodiac ring having sectors evenly divided among the twelve signs of the zodiac. Such a zodiac ring can be used for any individual by adjusting the zodiac ring so that the angle of the angle of the ascendant sign of the zodiac, as determined by the individual's horoscope, is set at the beginning of the first house on an associated ring that is equally divided among twelve house sections. Conventionally, this means that the angle of the ascendant sign is set at the left end of a horizontal line extending through the ring divided among the houses.

However, the method most commonly used now in the preparation of horoscopes for dividing the space within zodiac among the twelve signs is a method described by Placidus in 1688, in which the various signs are assigned different angles of the zodiac based on the times taken for each degree of the ecliptic to move from rising at the horizon to the midheaven directly above at the time and location of the individual's birth. What is needed, to provide a device of particular value to astrologers and to serious students of astrology, is a method for displaying a horoscope that includes a zodiac ring divided among the signs in accordance with the birth time and location of an individual.

### SUMMARY OF THE INVENTION

According to a first aspect of the invention a device is provided for displaying a horoscope. The device includes a housing, and, held within the housing, a lamp, a zodiac plate, and a planetary plate. The housing has an opening in front of the planetary plate. The zodiac plate, which is illuminated by the lamp, is divided into twelve wedge-shaped sections extending around the zodiac plate in locations determined according to the horoscope. The planetary plate, which is disposed in front of the zodiac plate and spaced away from the zodiac plate, includes a transparent plate and symbols on the transparent plate representing a sun, a moon, and planets in locations aligned with the wedge-shaped sections of the zodiac plate as the sun, moon, and planets are aligned with zodiac regions in space according to the horoscope.

The spacing between the planetary plate and the zodiac plate makes the planets appear to float in front of the sections of the zodiac plate as the planetary plate is viewed through the opening in the housing.

Preferably, the opening in the housing is divided into twelve wedge shaped portions by tracery including horizontal elements. The tracery, which represents the ornamental architectural structures extending within a round window of a Gothic cathedral, may be formed by raised portions of a transparent window extending across the opening or by a structure forming a part of the housing extending across the opening.

Preferably, the zodiac plate is translucent, and the lamp is disposed behind the zodiac plate, with translucency being understood to include transparency. The wedge-shaped sections of the zodiac plate are preferably formed of differently colored materials.

According to another aspect of the invention, a method is or building a device for displaying a horoscope. The method includes:

determining an ascendant sign, an angle of ascension, and locations of a sun, moon, and planets in accordance with the horoscope;

constructing a zodiac plate including wedge-shaped sections representing zodiac signs, with a section representing the ascendant sign being disposed at the angle of ascention;

constructing a planetary plate including a transparent sheet having symbols representing a sun, a moon, and planets aligned with the sections in the zodiac plate in the locations determined in accordance with the horoscope, and

installing the planetary plate within a housing behind an opening within the housing; and

installing the zodiac plate within the housing behind the planetary plate, in alignment with the planetary plate, and spaced apart from the planetary plate.

### BRIEF DESCRIPTION OF THE FIGURES

FIG. 1 is a perspective view of a display device constructed in accordance with a first embodiment of the present invention to display a horoscope of an individual;

FIG. 2 is a front elevation of the display device of FIG. 1;

FIG. 3 is a bottom plan view of the display device of FIG. 1, shown with a base removed to reveal internal details;

FIG. 4 is a fragmentary cross-sectional view of the display device of FIG. 1, taken as indicated by section lines 9-9 in FIG. 3;

FIG. 5 is a front elevation of zodiac plate within the display device of FIG. 1;

FIG. 6 is a front elevation of a planetary plate within the display device of FIG. 1;

FIG. 7 is a fragmentary cross sectional view of the planetary plate of FIG. 6;

FIG. 8 is a fragmentary cross-sectional view of an process for making the planetary plate of FIG. 6;

FIG. 9 is a cross-sectional front view of the display device of FIG. 1, taken as indicated by section lines 9-9 in FIG. 3;

FIG. 10 is a right elevation of the display device of FIG. 1;

FIG. 11 is a rear elevation of the display device of FIG. 1;

FIG. 12 is a plan view of the display device of FIG. 1;

FIG. 13 is a fragmentary plan view of the display device of FIG. 1, taken as indicated by section lines 13-13 in FIG. 11, to show the attachment of a lamp and an inner reflector to a main reflector;

FIG. 14 is a bottom plan view of the display device of FIG. 1;

FIG. 15 is a fragmentary plan view similar to FIG. 13, except that an alternate means for switching the lamp is provided;

FIG. 16 is a cross-sectional right elevation of a display device constructed in accordance with a second embodiment of the present invention to display a horoscope; and

FIG. 17 is a cross-sectional front elevation of the display device of FIG. 16, taken as indicated by section lines 17-17 therein to show a zodiac plate. n as indicated by section line 4-4 in FIG. 3;

### DETAILED DESCRIPTION OF THE INVENTION

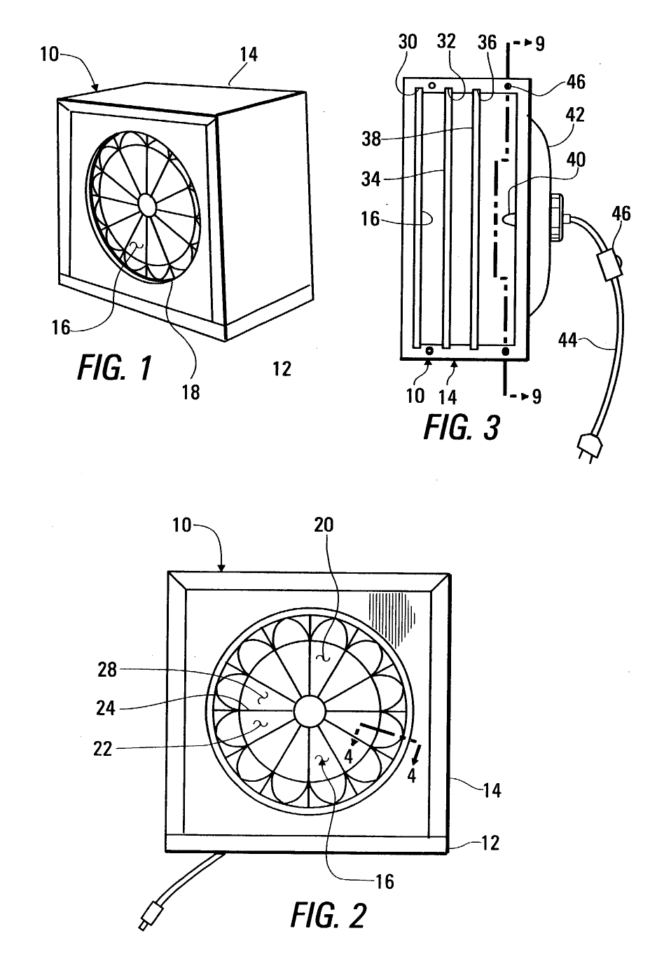

FIG. 1 is a perspective view of a display device 10 built in accordance with a first embodiment of the present invention. The display device 10 includes a base 12, a housing 14 fastened to the base 12, and a window 16 visible through a hole 18 in the housing 14. When the display device 10 is internally illuminated, various aspects of an individual horoscope can be seen through the window 16.

FIG. 2 is a front elevation of the display device 10. The window 16 includes tracery 19 dividing its circular space into twelve equal segments 20, corresponding to the twelve houses of an individual horoscope, starting with a first section 22, representing a first house, disposed adjacent a horizontal tracery element 24 representing to position of the horizon relative to the zodiac at the time of the individual's birth. The houses being represented continue around in the direction of arrow 26, with the twelfth house being represented by the twelfth section 28. The window 16 is additionally reminiscent of a round window pattern found in many gothic cathedrals, whether built during the Middle Ages or at a later time while copying the gothic style. Such a window, often called a rose window, is found, for example, in the Cathedral of Notre Dame, in the Chartres Cathedral in France, and in the Cathedral of St. John the Devine in New York City.

FIG. 3 s a bottom plan view of the display device 10, shown with the base 12 removed to reveal the internal structure of the device 10. The housing 14 includes a first groove 30 holding the window 16, a second groove 32 holding a planetary plate 34, and third groove 36 holding a zodiac plate 38. The display device 10 is internally illuminated by a light bulb 40, mounted within a main reflector 42 and powered through a line cord 44. A switch 46 may be additionally included to allow the light bulb 44 to be turned off and on without unplugging the line cord 44 from a source of electrical power. The housing 14 additionally includes threaded holes 46 for removably mounting the base 12.

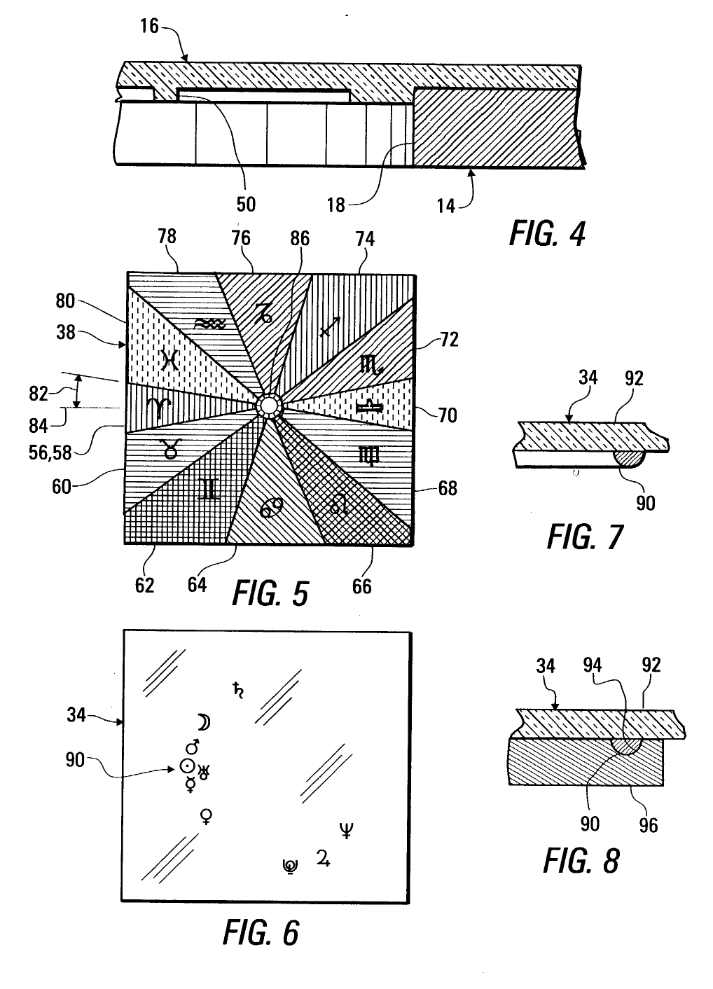

FIG. 4 is a fragmentary cross-sectional view of the display device 10, taken as indicated by section line 4-4 in FIG. 2 to show the structure of the window 16. The window 16 is preferably composed of a clear transparent thermoplastic resin or a clear transparent glass material, with raised sections 50 forming the tracery described in reference to FIG. 2 as dividing the window into twelve sections 20, together with other decorative markings. Preferably, the raised sections 50 are painted using an opaque paint to simulate the leading of a stained glass window.

FIG. 5 is a front view of the zodiac plate 38 held within the display device 10 as described above in reference to FIG. 3. Preferably, the zodiac plate 38 is composed of a transparent material, such as glass or a thermoplastic resin, with painted or coated wedge-shaped sections 56 representing the twelve signs of the zodiac. Each of these sections 56 includes a symbol representing the sign of the zodiac associated with the section. Each of these sections 56 is preferably painted or coated with a color traditionally associated with the sign represented by the section. For example, the zodiac plate 38 includes a red Aries section 58, a light blue Taurus section 60, a yellow Gemini section 62, a light green Cancer section 64, an orange Leo section 66, a dark blue Virgo section 68, a violet Libra section 70, a maroon Scorpio section 72, a strawberry pink Sagittarius section 74, an electric blue Aquarius section 78, and a purple Pisces section 80.

The zodiac plate 38 preferably represents the division of the sky into sections assigned to the various signs at a particular location and moment, such as the birth of an individual, in accordance with a traditional astrological method for making such a division. For example, the division of the sky may be made according to is a method described by Placidus in 1688, in which the various signs are assigned different angles of the zodiac based on the times taken for each degree of the ecliptic to move from rising at the horizon to the midheaven directly above at the time and location of the horiscope being represented. Such a method provides an unequal division of the space among the various signs, as shown in the example of FIG. 5.

Regardless of the method by which the zodiac space is divided, the sector representing the sign determined in the horoscope to be the ascendant of the horoscope is preferably displayed as extending centrally toward the left, beginning at an angle 82 above a horizontal axis 84 of the zodiac plate 38, with the angle 82 being determined according to the angle of ascension of the horoscope being represented. In the example of FIG. 5, Aries is the ascendant, with the angle of ascension being fifteen degrees. In accordance with the invention, the horizontal axis 84 passes through the center of the zodiac plate 38, with the horizontal axis 84 being aligned in the display device 10 with the horizontal marking 24 of the window 16 (shown in FIG. 2). A jewel 86, composed of glass or of a thermoplastic resin, is preferably adhesively attached at the center of the zodiac plate 38, with the center of this plate 38 being aligned with the center of the window 16.

FIG. 6 is a front view of the planetary plate 34, described above in reference to FIG. 3, which includes symbols 90 representing the sun, the moon, and various planets. In accordance with the invention, the symbols 90 are located on the planetary plate 34 in alignment with positions on the zodiac plate 36 corresponding to the locations of the sun, moon, and planets represented by the individual symbols at the birth time of the horoscope being represented by the display device 10. The locations of the planets relative to the sections of the zodiac are preferably determined by a conventional and accepted method of making a horoscope. In this way, the symbols 90 are also placed in alignment with the houses represented by the markings on the markings on the window 16, as described above in reference to FIG. 1. Conditions of alignment among the zodiac plate 38, the planetary plate 34 and the window 16 are understood to be alignment in the horizontal and vertical directions perpendicular to the window 16, so that such alignments can be readily seen by looking straight into the window 16.

FIG. 7 is a fragmentary cross-sectional view of the planetary plate 34, which is additionally taken through a portion of one of the symbols 90. Each of the symbols 90 is, for example, a three dimensional element having a raised and rounded cross-section, being composed of a colored thermoplastic resin or of a colored glass, and being adhesively attached to the plate 92, which is composed of a clear thermoplastic or glass material.

FIG. 8 is a fragmentary cross-sectional view of the planetary plate 34, showing an alternative method for forming the symbols 90. In this method, each of the symbols 90 is formed by a thermoplastic resin in cavity 94 within a movable block 96, with the movable blocks 96 being positioned so that the symbols 90 are transfer molded to the plate 92, being placed in the locations described above in reference to FIG. 6.

Other processes for forming raised symbols on a flat surface are based on applying slow drying ink to the surface in the areas in which the symbols are to be formed, and by then applying a layer of thermoplastic powder to the flat surface. The thermoplastic powder sticks to the wet ink but not to the rest of the flat surface. Heat is then applied to melt the thermoplastic powder together and to adhere the thermoplastic powder to the flat surface. The slow drying ink may be applied using an ink jet printer driven by a computer. An example of such a process is described in U.S. Pat. No. 5,627,578, the disclosure of which is incorporated herein by reference.

Such a process may be used to form the planet sheet 34, with the ink being deposited on a sheet of transparent thermoplastic material within an ink jet printer in response to a program executing within a computing system to generate and plot a horoscope. Then, after applying heat to form the raised symbols on the sheet, the sheet is laminated to a thicker layer of thermoplastic material or to a glass plate for rigidity.

FIG. 9 is a front cross-sectional view of the display device 10, taken as indicated by section lines 9-9 in FIG. 3 to show an internal view of the main reflector 42, which includes tabs 100 mounted to the housing 14 by means of screws 102. The main reflector 42 preferably includes an inner reflector 104, extending around the lamp 40 to provide a sparkling array of light reflections from a number of angled surfaces. The base 12 is attached to the housing 14 by screws 106 extending into threaded holes 46.

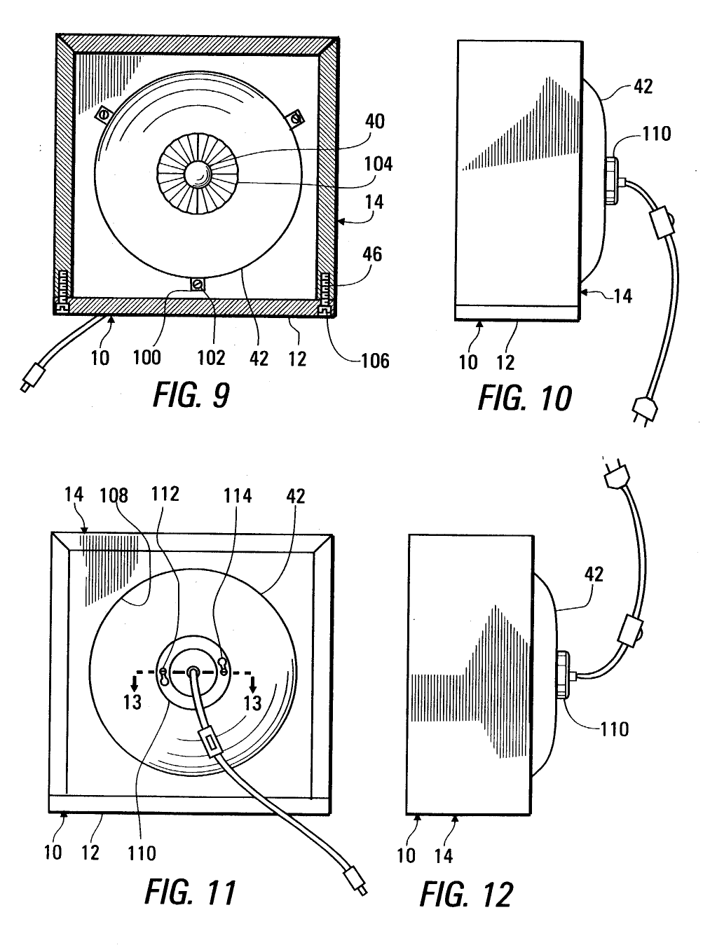

FIG. 10 is a right elevation of the display device 10. The left elevation of the device is a mirror image of the right elevation.

FIG. 11 is a rear elevation of the display device 10. The main reflector 40 extends outward through a rear hole 108 in the housing 14. In a central portion of the main reflector 108, a cap 110 is removable for replacement of the lamp 40 (shown in FIG. 9, by loosening a pair of screws 112, and by turning the cap 110 so that the heads of these screws 112 pass through openings 114 in the cap 110.

FIG. 12 is a plan view of the display device 10.

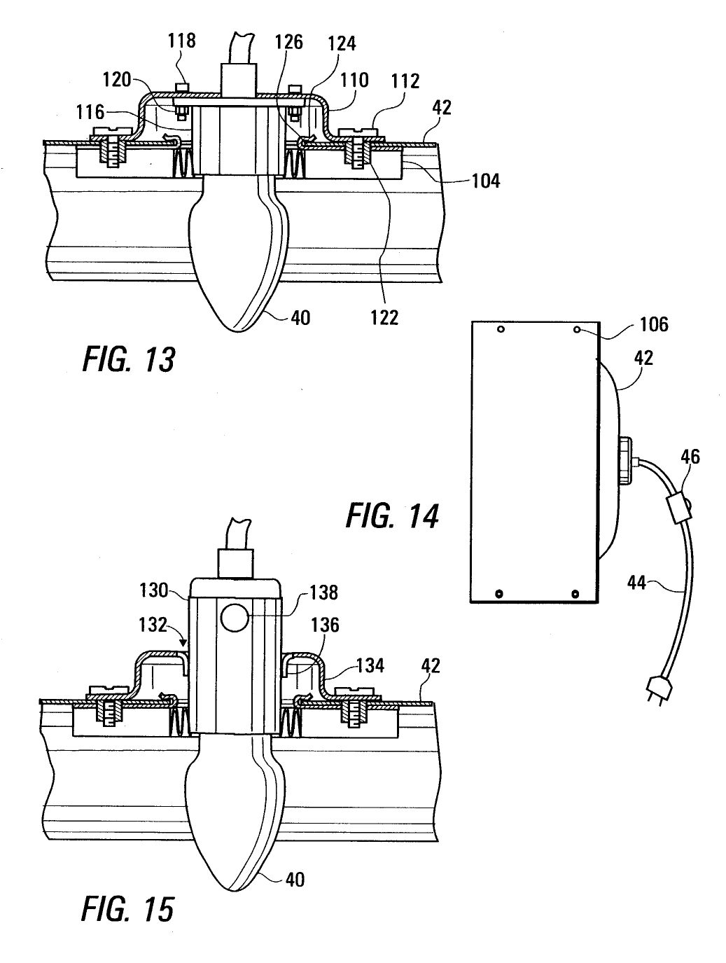

FIG. 13 is a fragmentary cross-sectional plan view of the display device 10, taken as indicated by section lines 13-13 in FIG. 11 to show the attachment of the lamp 40 and of the inner reflector 104 to the main reflector 42. The lamp 40 is, for example, a conventional screw-base type engaged within a threaded socket 116. The socket 116 is, in turn, fastened to the cap 110 by a pair of screws 118 and associated nuts 120. The cap 110 is held in place on the main reflector 42 by means of screws 112 engaging fasteners 122 swaged in place on the main reflector 42. The inner reflector 104 is attached to the main reflector 42 by means of a number of formed tabs 124. When the cap 110 is removed from the main reflector 42, as explained above in reference to FIG. 11, the socket 120 and bulb 40 can pulled outward through a central hole 126 in the main reflector 42 for replacement of the bulb 40.

FIG. 14 is a bottom plan view of the display device 10, showing the base 12 held in place by screws 106.

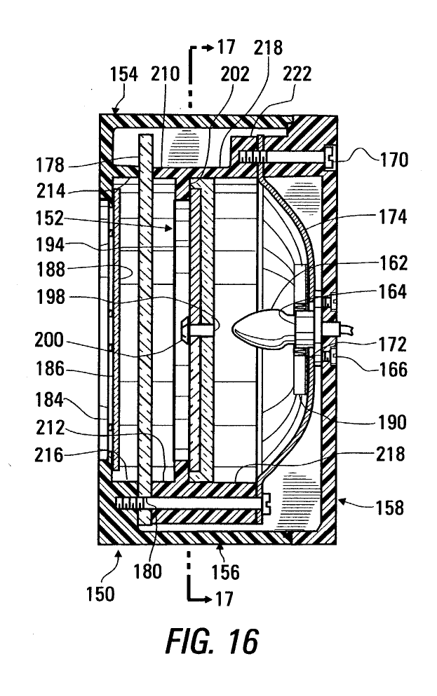

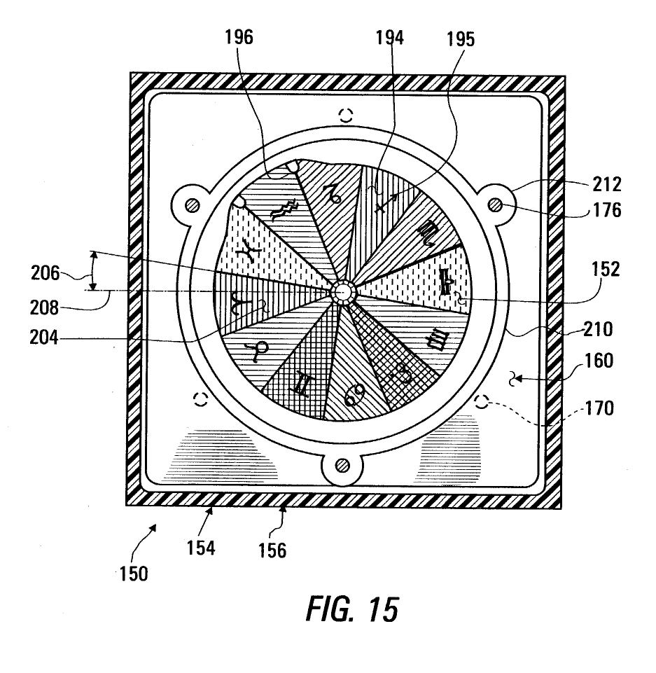

FIG. 15 is a fragmentary cross-sectional plan view, taken as the view of FIG. 13, but showing an alternative method for mounting the main reflector 42. With this method, a socket 130 is pressed into a hole 132 within an alternate cap 134, to be held in place by a number of fingers 136 extending within the cap 134. The socket 130 includes a switch actuated by turning an external knob 138, so that the switch 46 on the line cord 44 (shown in FIG. 14) is no longer required.

A number of computer programs are commercially available for developing horoscopes based on a location and time of birth. Such a program provides, for example, an output including a printed chart having the signs of the zodiac arranged in accordance astrological tradition for the time and location of birth, with unequal areas being assigned to various signs of the zodiac, as described above in reference to FIG. 5. Such a printed chart may be readily traced to color the twelve sections 56 of the zodiac plate 39.

Alternately, it is well known that a computer program can be modified to operate a color printer so that areas of a printed sheet are filled with different colors, with the areas being defined by parameters determined during execution of the program. A well-known example of such a program is a spreadsheet program printing calculated data in the form of a pie chart. Such a modification to a horoscope generating program to print colors assigned to the various sections 56 on a clear transparent sheet, which is then laminated to a thicker sheet to form the zodiac plate 39.

Commercially available computer programs for developing horoscopes also are known to print symbols for the sun, moon, and planets in the appropriate positions, according to astrological traditions, within the spaces allocated to the signs of the zodiac. Such a chart can readily be used to locate the symbols 50 on the planetary plate 34, with the symbols being attached as described in reference to FIG. 7 or 8. Alternately, such a program may be used to print symbols on a thin, clear transparent sheet using a slow-drying ink, with the actual symbols then being formed from a thermoplastic powder adhered to the ink, and with the thin sheet then being laminated to a thicker sheet to form the planetary plate 34.

An alternative display device 150, built for displaying a horoscope in accordance with a second embodiment of the invention, will now be discussed with reference to FIGS. 16 and 17. FIG. 16 is a cross-sectional right elevation of the alternative display device 150, while FIG. 17 is a cross-sectional front elevation thereof, taken as indicated by section lines 17-17 in FIG. 16 to particularly show a zodiac plate 152.

The alternative display device 150 includes a housing 154 comprising a front cover 156, a rear cover 158, and an internal frame 160. A lamp 162 is held within a socket 164 fastened to the rear cover 158 by screws 166. The rear cover 158, which engages the front cover 154 along stepped edges 168, is fastened to the internal frame 160 by three screws 170. Thus, lamp 162 can be removed and replaced by removing the rear cover 158 after loosening the screws 170. As the rear cover is removed, the lamp 162 is moved outwardly through a central hole 172 in a main reflector 174.

The inner frame 160 is fastened to the front cover 154 by three screws 176, which also fasten the main reflector 174 to the inner frame 160. The screws 176 additionally fasten a planetary plate 178 in place between the inner frame 160 and the front cover 154.

The front cover 154 includes tracery 184 providing twelve equally spaced openings 186, arranged as described above in reference to FIG. 2, to represent twelve houses of a horoscope. A clear plate 188, composed of glass or of a plastic resin and adhesively attached to the front cover 154 provides a window into the alternate display device 150.

Preferably, an inner reflector 190 is fastened to the main reflector by tabs (not shown) in the general manner described above in reference to FIG. 13.

The zodiac plate 152 includes a support wheel 192, composed of a clear, transparent thermoplastic resin, and a number of wedge-shaped sections 194, each of which is composed of a colored transparent or translucent thermoplastic resin. The individual sections 194 are arranged to represent the twelve signs of the zodiac, with each of the sections 194 including a symbol 195 representing an associated sign of the zodiac. Preferably, each of the twelve sections 194 is colored in a manner traditionally associated with the particular sign of the zodiac represented by the section 194, as listed above in reference to FIG. 5.

In FIG. 17, a portion of the inner frame 160 is shown as cut away to reveal a pair of tabs 196 extending from the support wheel 192 to assist in the proper location of the sections 194. The narrow ends of the sections 194 are held in place by a pin 198, which is adhesively attached to the wheel 192, or which snaps into place. The pin 198 includes a head 200 simulating a jewel. The individual sections 194 may be adhesively attached to the support wheel 192, or they may simply be held in place against the adjacent annular surface 202 of the inner frame 160 when the support wheel 192 is adhesively attached within the inner frame 160.

In the example of FIG. 17, the twelve wedge-shaped sections 194 are of equal size, so that a horoscope having the space in the zodiac divided evenly among the twelve signs, according to the oldest method for making such a division, is represented. This method has the advantage of requiring the same pattern of sections 194 for each horoscope, requiring only that the section 204 representing the ascendant sign must be set at the angle of ascension 206, determined within the horoscope being displayed, above a horizontal line 208 extending through the center of the zodiac plate 152.

The planetary plate 178 includes symbols representing the sun moon and planets, being constructed generally as described above in reference to FIGS. 6-8 with the addition of holes 180 for attachment. These symbols are aligned with the sections 194 of the zodiac wheel 152 according to the alignment of the sun, moon, and planets with the signs represented by the individual sections 194, as determined in the horoscope being represented by the alternative display device 150.

The inner frame 160 includes a first ring 210 and associated bosses 212 extending forward to clamp the planetary plate 178 against a ring 214 and associated bosses 216 extending rearward as a part of the front cover 154. The inner frame 160 additionally includes a second ring 218 and associated bosses 220 extending rearward for attachment to the main reflector 177, with the zodiac plate 152 being adhesively attached within this second ring 218. Bosses 222, additionally extending outward from the second ring 218, are provided for attaching the rear cover 158 to the inner frame 160.

A commercially available computer program may be used to determine the ascendant and the angle of ascension for a particular horoscope to be represented by the alternative display device 150, with this information then being used to determine the angle at which the zodiac plate 152 is attached within the inner frame 160. The output of such a computer program may also be used to form the planetary plate 178 as described above for making the planetary plate 34 of the display device 10.

Various features of the display device 10 and of the alternative display device 150 may be combined. For example, a zodiac plate having segments of unequal size, as described in reference to FIG. 5, may be used in a display device having an enclosed lamp and reflector, as described in reference to FIGS. 16 and 17.

While horoscopes that can be represented by the display devices 10, 150 are traditionally prepared for individuals based on the times and locations of their birth, it is understood that horoscopes that can be similarly represented are additionally prepared for other events occurring at particular times and locations, such as weddings and the founding of cities.

While the invention has been described in its preferred embodiments with some degree of particularity, it is understood that this description has been given only by way of example, and that many variations may be made without departing from the scope and spirit of the invention.

1. A device for displaying a horoscope, wherein said device comprises:
a housing;
a lamp held within said housing;
a zodiac plate held within said housing and illuminated by said lamp, wherein said zodiac plate is divided into twelve wedge-shaped sections extending around said zodiac plate in locations determined according to said horoscope;
a planetary plate held within said housing in front of said zodiac plate and spaced away from said zodiac plate, wherein said planetary plate includes a transparent plate and symbols on said transparent plate representing a sun, a moon, and planets in locations aligned with said wedge-shaped sections of said zodiac plate as said sun, moon, and planets are aligned with zodiac regions in space according to said horoscope; and
an opening in said housing in front of said planetary plate.

2. The device of claim 1, wherein said opening in said housing is divided into twelve wedge-shaped portions of equal size extending around said opening.

3. The device of claim 2, wherein said opening in said housing is divided into said twelve wedge-shaped portions by tracery including horizontal elements.

4. A device for displaying a horoscope, wherein said device comprises:
a housing;
a lamp held within said housing;
a zodiac plate held within said housing and illuminated by said lamp, wherein said zodiac plate is divided into twelve wedge-shaped sections extending around said zodiac plate in locations determined according to said horoscope;
a planetary plate held within said housing in front of said zodiac plate and spaced away from said zodiac plate, wherein said planetary plate includes a transparent plate and symbols on said transparent plate representing a sun, a moon, and planets in locations aligned with said wedge-shaped sections of said zodiac plate as said sun, moon, and planets are aligned with zodiac regions in space according to said horoscope; and
an opening in said housing in front of said planetary plate, wherein said opening in said housing is divided into twelve wedge-shaped portions of equal size extending around said opening by tracery including horizontal elements, and
a transparent window plate extending across said opening, wherein said window plate includes raised sections forming said tracery.

5. A device for displaying a horoscope, wherein said device comprises:
a housing;
a lamp held within said housing;
a zodiac plate held within said housing and illuminated by said lamp, wherein said zodiac plate is divided into twelve wedge-shaped sections extending around said zodiac plate in locations determined according to said horoscope;
a planetary plate held within said housing in front of said zodiac plate and spaced away from said zodiac plate, wherein said planetary plate includes a transparent plate and symbols on said transparent plate representing a sun, a moon, and planets in locations aligned with said wedge-shaped sections of said zodiac plate as said sun, moon, and planets are aligned with zodiac regions in space according to said horoscope; and
an opening in said housing in front of said planetary plate, wherein said opening in said housing is divided into twelve wedge-shaped portions of equal size extending around said opening by tracery including horizontal elements, and wherein said tracery is formed as a part of said housing extending across said opening.

6. The device of claim 1, wherein said wedge-shaped sections of said zodiac plate are individually colored.

7. The device of claim 6, wherein
said zodiac plate is translucent, and
said lamp is disposed behind said zodiac plate.

8. The device of claim 7, additionally comprising an inwardly concave main reflector disposed behind said lamp.

9. The device of claim 8, additionally comprising an inner reflector extending around said lamp in front of said main reflector.

10. The device of claim 7, wherein said zodiac plate comprises a translucent plate having colored coatings extending along a side of said zodiac plate to form said wedge-shaped sections of said zodiac plate.

11. The device of claim 7, wherein said zodiac plate comprises a clear translucent plate and colored translucent segments attached to extend around said clear translucent plate to form said wedge-shaped sections of said zodiac plate.

12. The device of claim 1, wherein each said wedge-shaped section of said zodiac plate includes a symbol representing a zodiac sign represented by said wedge-shaped section.

13. The device of claim 1, wherein said wedge-shaped sections of said zodiac plate are of sizes varying from one another in accordance with said horoscope.

14. The device of claim 1, wherein said wedge-shaped sections of said zodiac plate are of equal size.

15. The device of claim 14, wherein said zodiac plate comprises a circular disk attached within an inner opening in said housing at an angle determined in accordance with said horoscope.

16. A method for building a device for displaying a horoscope, wherein said method comprises:
determining an ascendant sign, an angle of ascension, and locations of a sun, moon, and planets in accordance with said horoscope;
constructing a zodiac plate including wedge-shaped sections representing zodiac signs, with a section representing said ascendant sign being disposed at said angle of ascension;
constructing a planetary plate including a transparent sheet having symbols representing a sun, a moon, and planets aligned with said sections in said zodiac plate in said locations determined in accordance with said horoscope, and
installing said planetary plate within a housing behind an opening within said housing; and
installing said zodiac plate within said housing behind said planetary plate, in alignment with said planetary plate, and spaced apart from said planetary plate.

17. The method of claim 16, wherein
said zodiac plate is translucent, and
said method additionally comprises installing a lamp within said housing behind said zodiac plate.

18. The method of claim 16, wherein said wedge-shaped sections vary in size from one another in accordance with said horoscope.

19. The method of claim 16, wherein
said wedge-shaped sections are similar in size, and
said wedge shape sections comprise a round structure installed at an angle determined from said ascendant sign and said angle of ascension.

20. The method of claim 16, wherein
said opening within said housing is divided into twelve wedge-shaped portions by tracery including horizontal elements, and
said planetary plate and said zodiac plate are installed in alignment with said opening.
